(19) United States
(12) Patent Application Publication
(10) Pub. No.: US 2015/0264017 A1
(43) Pub. Date: Sep. 17, 2015

(54) SECURE VEHICLE DATA COMMUNICATIONS

(71) Applicants: Mustafa Saed, Bloomfield Hills, MI (US); Muhammad Rizwan, Canton, MI (US)

(72) Inventors: Mustafa Saed, Bloomfield Hills, MI (US); Muhammad Rizwan, Canton, MI (US)

(73) Assignees: HYUNDAI MOTOR COMPANY, Seoul (KR); HYUNDAI AMERICA TECHNICAL CENTER, INC., Superior Township, MI (US); KIA MOTORS CORPORATION, Seoul (KR)

(21) Appl. No.: 14/210,777

(22) Filed: Mar. 14, 2014

(51) Int. Cl. H04L 29/06; H04W 12/04

(52) U.S. Cl. CPC H04L 63/045; H04L 63/0428; H04L 63/0492; H04W 12/04

(57) ABSTRACT

A method for performing a remote control operation in a vehicle is provided. The method includes receiving, at telematics electronics of a vehicle, versions of a remote control command sent wirelessly to the vehicle by a dispatcher service. The versions of the remote control command are text-based messages encrypted by the dispatcher service using a first encryption mechanism. The method also includes decrypting the versions of the remote control command received from the dispatcher service into a plain text command. The method further includes encrypting the plain text command using a second encryption mechanism for use within the vehicle. The method additionally includes providing the command encrypted using the second encryption mechanism to another controller within the vehicle.

### BACKGROUND

(a) Technical Field

The present disclosure relates to a system for securing data communications transmitted to a controller of a vehicle.

(b) Background Art

The use of computerized control modules in vehicles has increased dramatically in recent years. For example, a new automobile may include an engine control unit (ECU) that controls engine operations, such as ignition timing, the air/fuel ratio used by the engine, idle speed, etc. In general, vehicle control modules are of two varieties: 1.) self-regulating control modules that automatically control the operation of a portion of the vehicle based on sensor input and 2.) control modules that perform a control operation in response to receiving a command from another control module.

To support communication between the different control modules in a vehicle, each control module may be connected to a localized network within the vehicle. For example, most modem vehicles include a localized network based on the controller area network (CAN) bus standard. At each node in a CAN bus is a CAN controller that coordinates the receiving and transmitting of messages to and from the node.

One area of interest that has emerged from the use of computerized control modules in vehicles is the remote control of the vehicle's operations. For example, some modem vehicles are equipped with keyless entry systems that allow a user to unlock the vehicle using a key fob. In another example, some vehicles include remote starter systems that allow a user to start the vehicle from a remote location. However, both keyless entry and remote starter systems are limited in that they use near field communication, requiring the user to be in close proximity of the vehicle. In addition, security in these systems is typically limited to the specific type of control operation (e.g., security in a keyless entry system is only implemented between the remote transmitter and the keyless entry receiver in the vehicle). In other words, the localized networks in many vehicles are unsecured since outside access to the localized network of a vehicle is either nonexistent or extremely limited. Thus, the CAN bus protocol, for example, does not include any security features as part of the protocol.

In order to solve the problems in the related art, there is a demand for the development of a technique for providing a myriad of control commands to a vehicle from a remote location, while still ensuring the security of the commands both internally and externally to the vehicle.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a system for securing communications sent to a controller of a vehicle. In particular, the present invention includes techniques that allow secure communications to the vehicle from a remote location, such as a dispatcher, and within the localized network of the vehicle to the destination controller.

In one aspect, the present invention provides a method for performing a remote control operation in a vehicle is provided. The method includes receiving, at telematics electronics of a vehicle, versions of a remote control command sent wirelessly to the vehicle by a dispatcher service. The versions of the remote control command are text-based messages encrypted by the dispatcher service using a first encryption mechanism. The method also includes decrypting the versions of the remote control command received from the dispatcher service into a plain text command. The method further includes encrypting the plain text command using a second encryption mechanism for use within the vehicle. The method additionally includes providing the command encrypted using the second encryption mechanism to another controller within the vehicle.

In one aspect, the second encryption mechanism may be based in part on a seed value generated during an ignition cycle of the vehicle. The method may also include receiving an encrypted version of the seed value at the telematics electronics, decrypting the received version of the seed value, and storing the seed value in memory, according to one embodiment.

In some embodiments, authentication is used to authenticate the remote control command received from the dispatcher by comparing transmittal times associated with the versions of the control command. An authentication string may also be associated with the command encrypted using the second encryption mechanism and provided in conjunction with the command encrypted using the second encryption mechanism to the other controller, according to another embodiment.

In a further embodiment, wherein the command encrypted using the second encryption mechanism is provided to a body control module (BCM) of the vehicle. In yet another embodiment, the command encrypted using the second encryption method is provided to the other control module in the vehicle via a control area network (CAN) bus.

In another embodiment of the present invention, an apparatus is disclosed. The apparatus includes one or more network interfaces adapted to communicate in a vehicle, a processor adapted to execute one or more processes, and a memory configured to store a process executable by the processor. The process when executed is operable to receive versions of a remote control command sent wirelessly to the vehicle by a dispatcher service. The versions of the remote control command are text-based messages encrypted by the dispatcher service using a first encryption mechanism. The process when executed is also operable to decrypt the versions of the remote control command received from the dispatcher service into a plain text command and to encrypt the plain text command using a second encryption mechanism for use within the vehicle. The process when executed is further operable to provide the command encrypted using the second encryption mechanism to another controller within the vehicle.

In an additional embodiment, an apparatus is disclosed. The apparatus includes one or more network interfaces adapted to communicate in a vehicle, a processor adapted to execute one or more processes, and a memory configured to store a process executable by the processor. The process when executed is operable to receive an encrypted command from telematics electronics of the vehicle, where the command was received by the telematics electronics from a remote location outside of the vehicle. The process when executed is also operable to authenticate that the encrypted command was sent by the telematics electronics and to decrypt the encrypted command if the encrypted command is authenticated. The process when executed is further operable to provide the decrypted command to a controller of the vehicle.

Advantageously, the systems and methods described herein allow any type of control operation to be sent to a vehicle from a remote source, such as a dispatcher service. Security mechanisms are also employed to ensure that intra-vehicle and extra-vehicle communications are secure.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram illustrating a remote communication system for a vehicle;

FIG. 2 is a diagram illustrating the various forms of data that may be used in the remote communication system of FIG. 1;

FIG. 3 is a diagram illustrating the use of the data from FIG. 2 within the remote communication system of FIG. 1;

FIG. 4 is a diagram illustrating security features implemented in the remote communication system of FIG. 1;

FIG. 5 is a state diagram illustrating the steps taken in an illustrative embodiment to secure a remote message sent to a controller of a vehicle; and

FIG. 6 is a flow diagram of a process for securing a remote message sent to a controller of a vehicle.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present disclosure will be described so as to be easily embodied by those skilled in the art.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that the below methods are executed by at least one controller. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention provides a system for securing communications sent to a controller of a vehicle. In particular, the present invention includes techniques that allow secure communications (e.g., remote control commands) to the vehicle from a remote location and within the localized network of the vehicle to the destination controller. In various embodiments, the remote control commands may be text-based messages received wirelessly by the vehicle.

Particularly, in the present disclosure, in order to fundamentally solve the problems of limited remote control operations available in a vehicle, security techniques are employed to secure both the transmission of a remote control command to the vehicle from a remote location and within the localized network of the vehicle to the destination controller. According to the present invention, a remote control command may be generated by a remote source, such as a user's mobile device. In one embodiment, the remote control command may be sent as a short message service (SMS) text message to a dispatcher service, which encrypts the command and forwards the encrypted command to the destination vehicle. In response to receiving an encrypted command from a remote source, a controller of the vehicle may authenticate the command, encrypt the command for transmission to another controller on the localized network of the vehicle, and forward the command to the destination controller for processing. Therefore, in the present invention, techniques are employed to ensure that control commands sent to a controller of a vehicle from a remote location are authentic both to and within the vehicle.

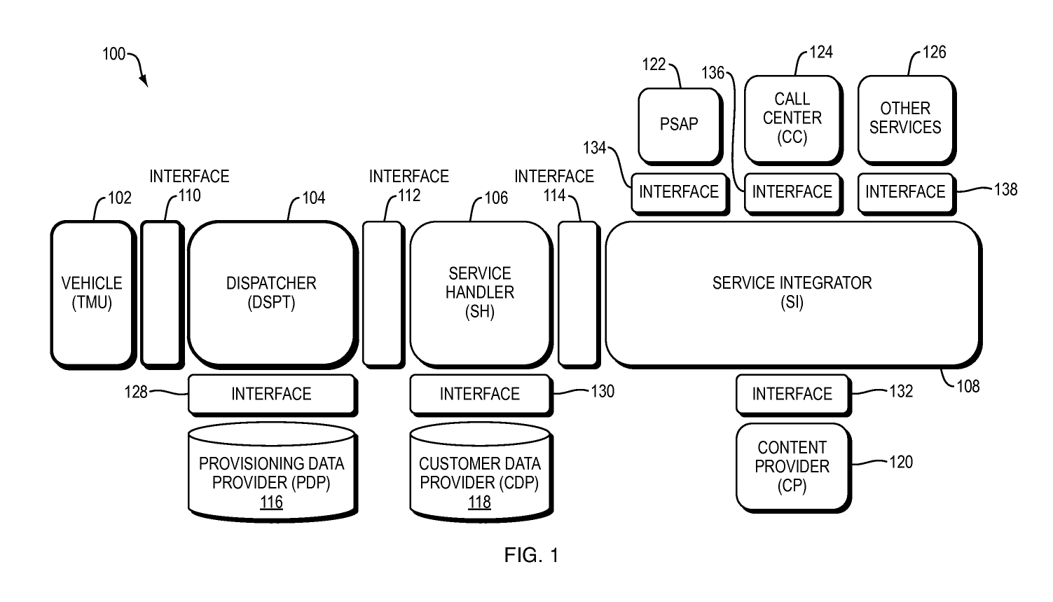

Referring to FIG. 1, a remote communication system 100 for a vehicle is shown. In general, communication system 100 allows data to be communicated to a vehicle from a remote source. For example, the vehicle may include a telematics unit (TMU) 102 (i.e., telematics electronics) configured to receive multimedia data from remote sources outside of the vehicle and to present the data to the occupants of vehicle 140 via a display and/or speakers located within the vehicle. The multimedia data may include, but is not limited to, weather data, navigational data, traffic data, news data (e.g., stock reports, sports scores, etc.), or any other form of data that may be of interest to a user located within the vehicle. Conversely, TMU 102 or another controller of the vehicle may be configured to transmit data from the vehicle to a remote location in system 100. For example, TMU 102 may transmit a request for data to a remote location, such as a request for traffic data. In some cases, the vehicle may communicate with a concierge service (e.g., TMU 102 may be configured to allow an occupant of the vehicle to converse with a remote concierge to coordinate roadside assistance, etc.).

Communication system 100 may include various devices to support the remote communication to and from the vehicle. As shown, TMU 102 of the vehicle may communicate wirelessly with a dispatcher service 104. In various embodiments, dispatcher service 104 may include a cellular or satellite transceiver configured to transmit and receive data wirelessly. In other embodiments, dispatcher service 104 may include a hardwired connection to a wireless service provider, such as a cellular service provider. An interface 110 may facilitate the transfer of data between TMU 102 and dispatcher 104. For example, dispatcher 104 may receive a request for data from TMU 102 via interface 110 or relay data received from a remote location to TMU 102. Dispatcher service 104 may also communicate via an interface 128 to receive provisioning data from a provisioning data provider (PDP) 116. For example, dispatcher 104 may receive and use cellular provisioning data from PDP 116 to establish a cellular connection with the vehicle.

Communication system 100 may include a service handler 106 that receives data requests from the vehicle via dispatcher 104 and/or transmits data to the vehicle via dispatcher 104. An interface 112 between dispatcher 104 and service handler 106 facilitates the transfer of data between the two systems and may include any number of wireless or hardwired connections. In general, service handler 104 may include the various computer systems of the manufacturer or servicer of TMU 102. For example, service handler 106 may include computer systems used by a concierge to support data requests from an occupant of the vehicle. In another example, service handler 106 may request and receive customer data from customer data provider (CDP) 118 via an interface 130. Such customer data may include account information (e.g., the billing history, etc.) for the vehicle's operator.

In various embodiments, communication system 100 includes a service integrator 108 that communicates with service handler 106 via interface 114. In general, service integrator 108 provides the requested data or other vehicle support functions sent to TMU 102 of the vehicle via service handler 106. Service integrator 108 may request and receive data from a content provider 120 via an interface 132. For example, service integrator 108 may provide requested traffic or weather data to TMU 102 via service handler 106. Service integrator 108 may also relay data between the vehicle and a call center. As shown, for example, service integrator 108 may relay data between TMU 102 and a public safety answering point (PSAP) 122 via interface 134 or a traditional call center 124 via interface 136. PSAP 122 may correspond to a call center used for emergency purposes, such as requesting help from police, a fire department, or ambulance service. Service integrator 108 may further relay data between the vehicle and other services 126 via interface 138, which may be any other form of service provider configured to provide requested data to the vehicle.

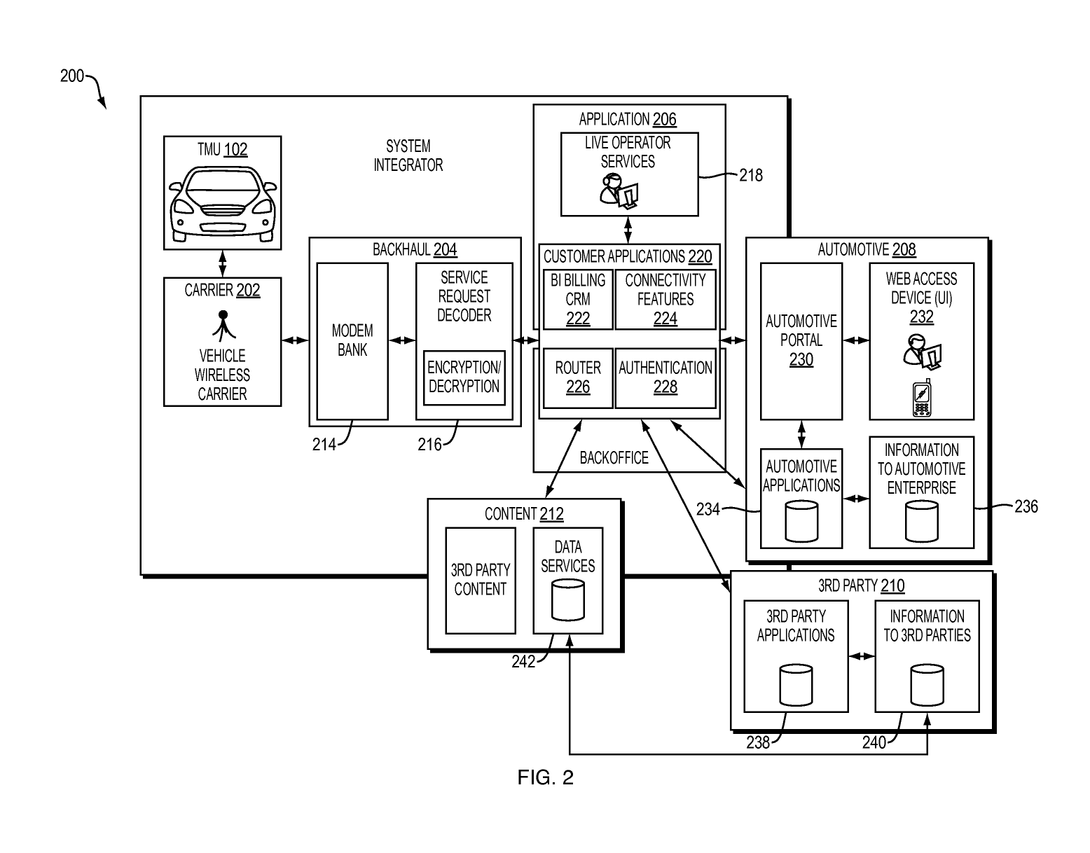

Referring now to FIG. 2, various forms of data that may be communicated to and from a vehicle within communication system 100 are shown in illustration 200. As shown, TMU 102 communicates wirelessly with a wireless carrier 202, which may be a cellular or satellite carrier service. For example, TMU 102 of the vehicle may be provisioned as a wireless device on a cellular network serviced by wireless carrier service 202. At the backhaul portion 204 of the wireless network (e.g., the intermediate network links between the wireless network and service handler 106) are a modem bank 214 and a service request decoder 216. Modem bank 214 includes any number of modems configured to communicate data over the wireless network serviced by wireless carrier 202. Service request decoder 216 includes the computing processes that translate data requests from the vehicle. Service request decoder 216 may also provide encryption and/or decryption services for the data communicated to and from the vehicle. For example, a data request sent from TMU 102 may include encrypted account or location information that is decrypted and forwarded by service request decoder 216.

At the backend of communication network 100 is an application backoffice 206 that includes any number of customer applications 220 operated by a live operator 218. For example, customer applications 220 may include a billing application 222, a connectivity application 224, a router application 226, an authentication application 228, or any other application that may be used by a backend operator to provide services to the vehicle. For example, an occupant of the vehicle may operate TMU 102 to speak with the live operator 218 about a billing question. In turn, operator 218 may use billing application 222 to retrieve and convey billing information back to the occupant of the vehicle.

Application backoffice 206 may also convey data from a third party 210 to the vehicle. Third party 210 may execute any number of third party applications 238 that receive data requests from customer applications 220 and/or provide third party content 212 to TMU 102 via customer applications 220. For example, assume that third party applications 238 include a navigation service. Customer applications 220 may provide information 240 to third party applications 238 via data services 242, such as the location of the vehicle as part of a navigation request. In turn, third party applications 238 may return third party content 212 (e.g., a map corresponding to the vehicle's location, etc.) to TMU 102 via customer applications 220.

In one embodiment, application backoffice 206 may include Internet services that provide an alternate communication method between a user and application backoffice 206 (e.g., as opposed to communicating with application backoffice 206 via wireless carrier service 202). As shown, an automotive portal 230 (e.g., a website, backend service for a mobile application, etc.) may provide a user interface to a web access device 232 operated by a user associated with the vehicle. For example, web access device 232 may be a desktop computer operated by the owner of the vehicle to access billing information from application backoffice 206 via portal 230. Portal 230 may also interface with any number of automotive applications 234 that communicate information 236 to or from the automotive enterprise.

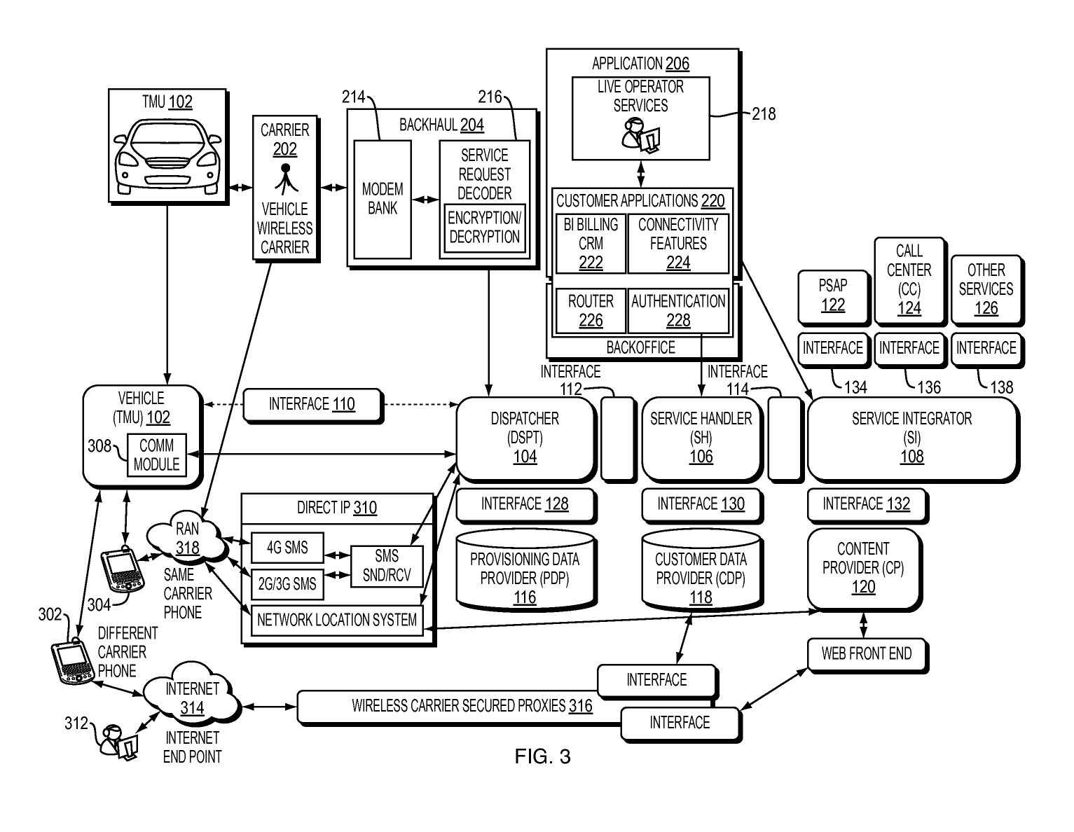

Referring now to FIG. 3, a diagram is shown illustrating the use of the data from FIG. 2 within the communication network 100 of FIG. 1. As shown, TMU 102 may include a communication module 308 configured to communicate over a radio area network (RAN) 318 provided by wireless carrier service 202. Various direct IP data 310, such as location data, text messages (e.g., SMS text, etc.), or the like may be transmitted to and from the vehicle via communication module 308.

In various embodiments, a user may operate a mobile or desktop computing device to send a remote control command to TMU 102. As shown, a user may operate a mobile device 304 (e.g., a cellular phone, a tablet device, etc.) that uses the same wireless carrier service 202 as TMU 102. A user may also operate a mobile device 302 that is on a different wireless carrier or an Internet end point device 312 (e.g., a desktop computer, a laptop computer, a tablet computer, etc.) to send a remote control command to TMU 102. Since devices 302, 312 are on different networks than that of RAN 318, a control command from either device may be conveyed via the Internet 314 to wireless carrier secured proxies 316. Wireless carrier secured proxies 316 may provide an interface between devices 302, 312, such as through a webpage front end portal.

In one embodiment, a control command may be sent by any of devices 302, 304, or 312 to TMU 102 via a text message (e.g., SMS text, etc.). For example, the owner of the vehicle may send a remote control command to the vehicle from mobile device 304, which is provided to TMU 102 of the vehicle as an SMS text message. However, the format and transmission of text messages to and from the vehicle and any of devices 302, 304, 312 may be dependent upon the configuration of wireless carrier service 202. Thus, in some implementations, text-based control commands sent to the vehicle may be encrypted first by the backend systems shown, to ensure that malicious control commands are not processed by the vehicle.

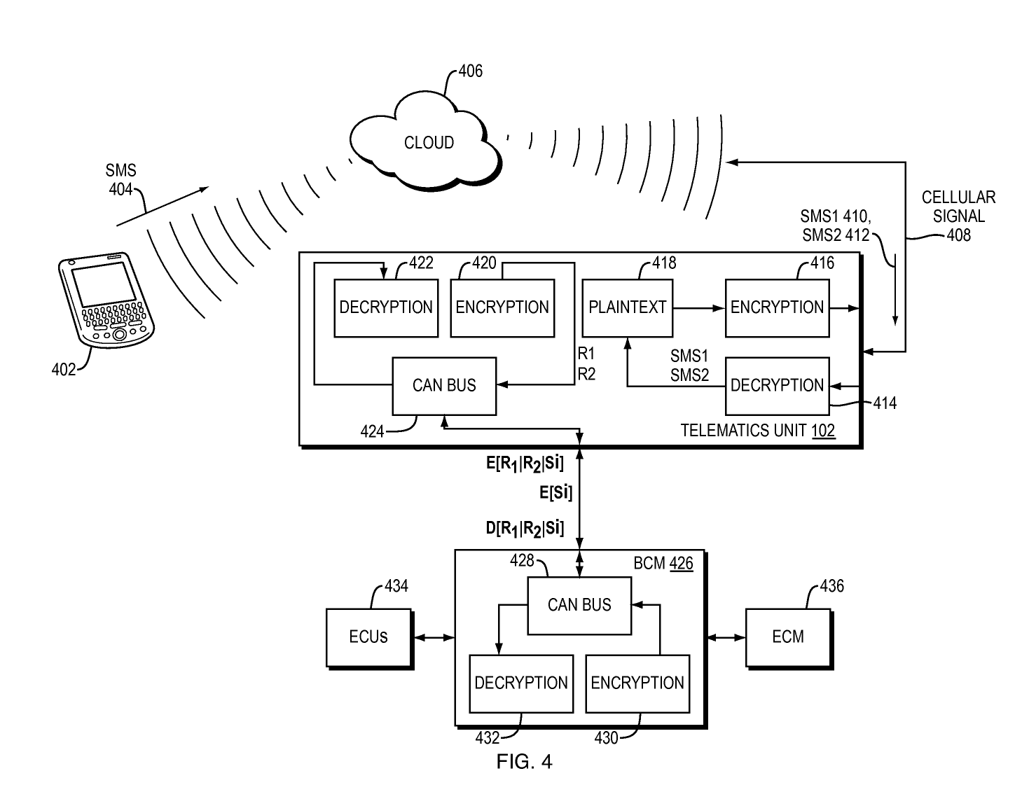

Referring now to FIG. 4, a diagram is shown illustrating security features implemented as part of remote communications system 100. As illustrated, a computing device 404 may send a remote control command 404 for the vehicle as an SMS text message to cloud 406 which represents the backend services shown in FIGS. 1-3 of communication system 100 (e.g., dispatcher 104, etc.). Control command 404 may be any command that can be transmitted on the localized network of the vehicle to any of the vehicle's controllers. In other words, control command 404 may correspond to any control command that is transmitted between controllers in the vehicle via the localized network of the vehicle.

In various embodiments, the backend services in cloud 406 receive control command 404 and validate that mobile device 402 is an authorized device to send remote control commands to the vehicle. For example, a unique device identifier associated with device 402 may be communicated as part of remote control command 404 and compared to an access list of device identifiers authorized to control the vehicle remotely. Example device identifiers may include, but are not limited to, a phone number of a sending device, a network address of a sending device (e.g., an IP address, etc.), a hardware-based identifier (e.g., a MAC address, a device serial number, etc.), a software-based identifier (e.g., a program registration key, etc.), combinations thereof, or a device identifier derived therefrom.

If remote control command 404 is authorized (e.g., the command is a valid command sent from an authorized device), the dispatcher in cloud 406 may forward remote control command 404 to the vehicle via a wireless signal 408 in the form of one or more encrypted, text-based messages. As shown, for example, the control command may be sent as a first encrypted command 410 and as a second encrypted command 412, both of which may be text messages (e.g., SMS messages). In one embodiment, encrypted commands 410, 412 include expiration parameters that cause the control command to expire if processed after the expiration parameter. The expiration parameters may also be used by the vehicle to validate that control commands 410, 412 were sent by the dispatcher service and not by a malicious entity.

In one embodiment, TMU 102 includes outward facing decryption and encryption modules 414, 416, respectively. Decryption module 414 is configured to receive and decrypt encrypted commands 410, 412 send to TMU 102 by the backend services in cloud 406 as a wireless signal. Decryption module 414 may, for example, use a decryption key mechanism shared only by the backend services (e.g., by dispatcher 104) and TMU 102 (e.g., the decryption key may be set by the manufacturer of TMU 102). Encryption module 416 may perform the opposite process to encrypt communications sent from TMU 102 to the backend services in cloud 406 and/or to device 402.

In some cases, commands 410, 412 may be sent at different times to help validate that the commands were sent by the backend services associated with TMU 102. For example, command 410 may be sent at a time t0 and command 412 may be sent at a time t0+30 seconds with a tolerance of +/−5 seconds. If the time difference between commands 410, 412 is not within the expected range, decryption module 414 may reject control commands 410, 412. Similarly, decryption module 414 may reject control commands 410, 412 if an expiration parameter associated with either command has been surpassed (e.g., command 410 expires at 10:00:31 AM and it is 10:00:45 AM).

Decryption module 414 may decrypt commands 410, 412 into plaintext 418 stored by TMU 102. Plaintext 418 includes the text-based version of remote control command 404 sent by device 402. For example, plaintext 418 may include text-based data such as a destination controller in the vehicle, a control code, parameters for the control code, or any other such information. As shown, plaintext 418 may include texts R1 and R2, which correspond to the plaintext contained within encrypted commands 410, 412, respectively.

In one embodiment, TMU 102 includes an interface module 402, such as a CAN bus controller, configured to communicate messages between TMU 102 and other controllers in the vehicle. Interface module 402 may include its own encryption and decryption modules 420, 422, which are configured to implement a second layer of encryption within the vehicle. In some embodiments, encryption and decryption modules 420, 422 are separate modules from encryption and decryption modules 416, 414 and may use different encryption techniques. In another embodiment, a single encryption and decryption module may be used by TMU 102 for purposes of securing both extra- and intra-vehicle communications.

As shown, encryption module 420 may generate an encrypted control command based on plaintext 418. For example, encryption module 420 may encrypt texts R1 and R2 using a seed value (Si) to form an encrypted control command for use within the vehicle. The seed value may be based on any timing mechanism shared by controllers in the vehicle, such as the ignition cycle of the vehicle. Interface module 424 of TMU 102 then sends the encrypted control command and an encrypted form of the seed value to a body control module 426 via the localized network of the vehicle.

Body control module (BCM) 426 may be a higher level control module of the vehicle that provides supervisory control over the various electronic systems of the vehicle. For example, BCM 426 may provide supervisory control over the vehicle's engine control module (ECM) 436 and/or any number of electronic control units (ECUs) 434 (i.e., other controllers). In general, ECM 436 provides control over the engine of the vehicle and its related functions (e.g., fuel to air ratio, etc.). ECUs 434 provide control over the other electronics in the vehicle. For example, ECUs 434 may control the automatic door locks of the vehicle, the power window actuators of the vehicle, the power windows of the vehicle, the lights of the vehicle, the climate control within the vehicle, etc. In one embodiment, ECM 436 or any of ECUs 434 also sends a new, encrypted seed value (E[Si]) to TMU 102 during each ignition cycle, thereby allowing TMU 506 to encrypt control messages for use in the localized network of the vehicle. The encrypted seed value (E[Si]) may be decrypted and stored by TMU 102 using a symmetric key K (e.g., TMU 102 may store the two latest seed values in memory).

BCM 426 includes an interface module 428 that performs similar functions as that of interface module 424. In other words, interface module 428 may be a CAN bus controller that is configured to receive and transmit messages on the localized network of the vehicle. In one embodiment, BCM 426 includes encryption and decryption modules 430, 432 that are configured to decrypt control commands sent to BCM 426 from TMU 102 and encrypt any status messages provided back to TMU 102 by BCM 426. As shown, decryption module 432 uses the received encrypted control command (E[R1|R2|Si]) to generate a decrypted control command (D[R1|R2|Si]). BCM 426 may then forward the decrypted control message to the appropriate ECU 434 or ECM 436, depending on the message type or on a destination controller specified within the control command. In response, ECM 436 or ECU 434 performs the requested control function.

As can be appreciated, modules 414-416, 420-422, 430-432, and interfaces 424, 428 of TMU 102 and BCM 426 may be implemented in hardware, software, or a combination thereof. For example, TMU 102 and BCM 426 may include one or more processors coupled to one or more memories that store instructions. When executed by the one or more processors, the instructions perform the functions described herein with respect to any or all of modules 414-416, 420-422, 430-432, and interfaces 424, 428. In another embodiment, some or all of modules 414-416, 420-422, 430-432, and interfaces 424, 428 may be implemented using an application specific integrated circuit (ASIC), field programmable gate array (FPGA), or the like.

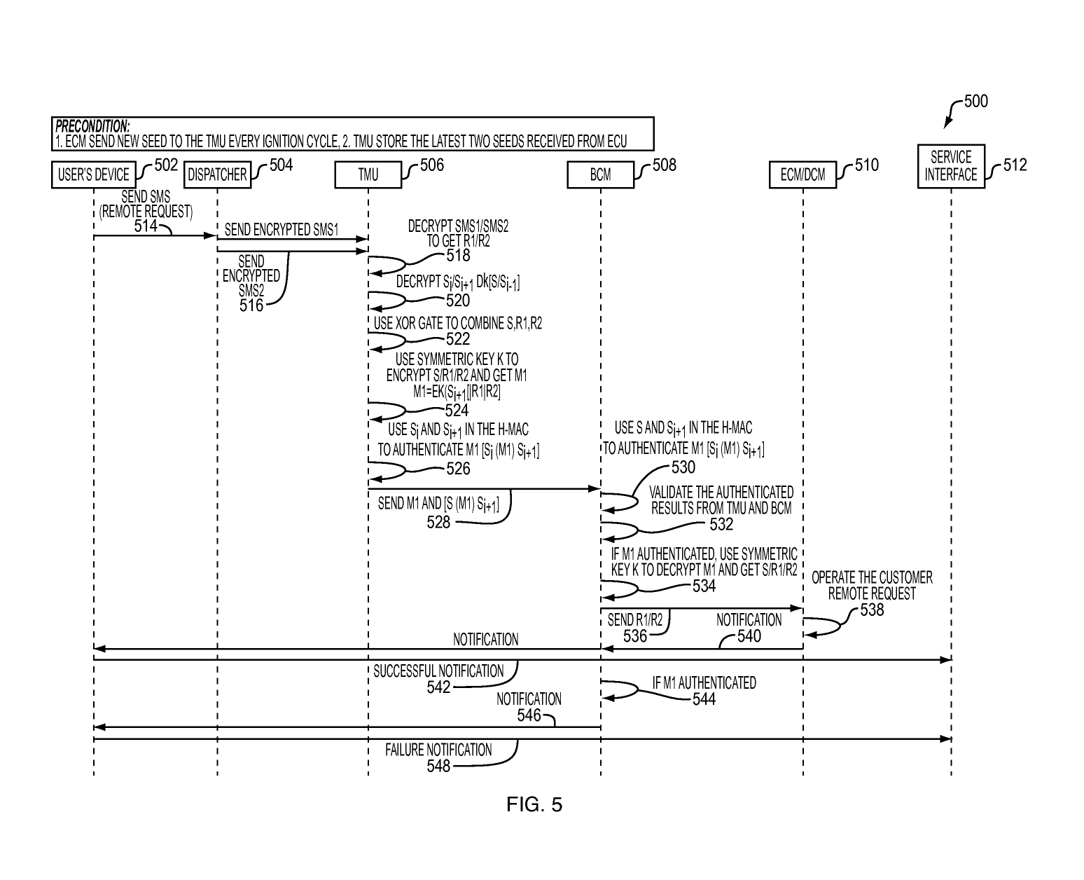

Referring now to FIG. 5, a state diagram 500 is shown illustrating the steps taken in an illustrative embodiment to secure a remote message sent to a controller of a vehicle. As shown, a number of devices implement the security mechanisms of the present invention. State diagram 500 may generally represent the steps taken by the system to remotely actuate the windows of a vehicle, enable or disable a light in the vehicle, or perform any other control function associated with the vehicle.

At step 514, a user's device 502 transmits a remote control command 514 to a dispatcher 502 as a text-based message. For example, control command 514 may be an SMS text message that includes a command to lower the windows of the vehicle by a certain amount (e.g., the user may remotely crack the windows of the vehicle on a hot day).

At step 516, dispatcher 504 encrypts the text of command 514 into two separate messages (SMS1, SMS2), if device 502 is an authorized device, and sends the encrypted messages to TMU 506 of the target vehicle. In one embodiment, the messages encrypted by dispatcher 504 are also text-based messages, such as SMS messages. The encrypted messages may include additional parameters added by dispatcher 504, such as expiration parameters that define a time period in which the messages are valid. In some cases, dispatcher 504 may also stagger the sending of the two encrypted messages, thereby allowing TMU 506 to validate that the messages were genuinely sent by dispatcher 504.

At step 518, TMU 506 uses a key shared with dispatcher 504 to decrypt the two encrypted messages into their respective texts R1, R2. For example, the key used by TMU 506 to decrypt the messages from dispatcher 504 may be set by the manufacturer of TMU 506, thereby keeping the encryption and decryption mechanisms between dispatcher 504 and TMU 506 protected from outside influence by malicious entities. At this point in the process, the raw control command transmitted by device 502 is available to TMU 506. In turn, TMU 506 takes additional measures to ensure that an encrypted form of the message is then transmitted within the internal network of the vehicle.

At step 520, TMU 506 decrypts seed values that are generated by the target ECM or ECU of the vehicle and sent to TMU 506 every ignition cycle. In one embodiment, TMU 506 stores the latest two seed values received from the ECM (e.g., seeds Si and Sᵢ₊₁), thereby allowing TMU 506 to decrypt the latest seed value.

At step 522, TMU 506 combines the decrypted texts of the two messages received from dispatcher 504 (e.g., texts R1 and R2) with the latest seed value (e.g., Sᵢ₊₁) to form a combined message payload. For example, TMU 506 may use an exclusive or operation (XOR operation) to combine the decrypted text messages with the latest seed value.

At step 524, TMU 506 uses a symmetric key (K) to encrypt the unified message generated in step 522 into an encrypted message (M1). In other words, key (K) may be used by TMU 506 for both encryption and decryption of messages passed between TMU 506 and the other controllers within the vehicle (e.g., BCM 508, ECM/DCM 510, etc.).

At step 526, TMU 506 authenticates the encrypted message (M1) using the latest two seed values (seeds Si and Sᵢ₊₁). For example, a hash-based message authentication code (H-MAC) may be generated to authenticate encrypted message (M1) by combining seeds Si and Sᵢ₊₁ with encrypted message (M1) to produce an authentication string ([Si, M1, Sᵢ₊₁]). The authentication string may be used by BCM 508 to ensure that the encrypted message (M1) was actually sent by TMU 506.

At step 528, the encrypted message (M1) containing the control command and the authentication string are sent by TMU 506 to BCM 508.

At step 530, BMC 508 uses the latest two seed values (seeds Si and Sᵢ₊₁) in the H-MAC to authenticate that the encrypted message (M1) was actually sent by TMU 506. In other words, BCM 508 uses the authentication string to verify that the encrypted message (M1) was sent by TMU 508.

At step 532, BCM 508 then validates the authenticated results from step 530. Based on this validation, BCM 508 may proceed to step 544 and determine that the message (M1) received from TMU 506 is not authenticated. In such a case, BCM 508 may return a notification in step 546 back to device 502 that the control command was not authenticated.

If the message (M1) received from TMU 506 is authenticated, BCM 508 proceeds to decrypt the message in step 534. BCM 508 may do so by using the symmetric key (K) to obtain the unified text generated in step 522 (e.g., R1, R2, and seed value Sᵢ₊₁). In other words, BCM 508 may reverse the process of step 524 to obtain the original text of the control command.

At step 536, BCM 508 sends the decrypted text (R1, R2) of the control command to the corresponding control module 510 (e.g., an ECM, ECU, etc.). In some cases, the plaintext control command includes routing information used by BCM 508 to direct the message to the appropriate controller. In other cases, BCM 508 directs the command to the appropriate unit based on the type of the command (e.g., an actuate window command may be sent to an ECU that controls the power windows of the vehicle).

At step 538, the device 510 being controlled performs the desired operation. For example, an ECM or ECU may adjust the climate control of the vehicle, actuate one or more windows, control the lighting of the vehicle, or perform any other control operation.

At step 540, a success notification is returned from the controlled device 510 back to the user's device. For example, the user's mobile device may be notified that the windows of the vehicle were lowered by one inch, as instructed.

At steps 542 and 548, respectively, a success notification or a failure notification may be sent by the user's device 502 to a service interface 512. Service interface 512 may be an interface to the backend services that support the vehicle and may record the success or failure. For example, too many failures within a given timeframe may be used by the backend service to trigger an alert (e.g., indicating that a mechanical problem may exist in the vehicle, that a number of unauthorized access attempts were made, etc.).

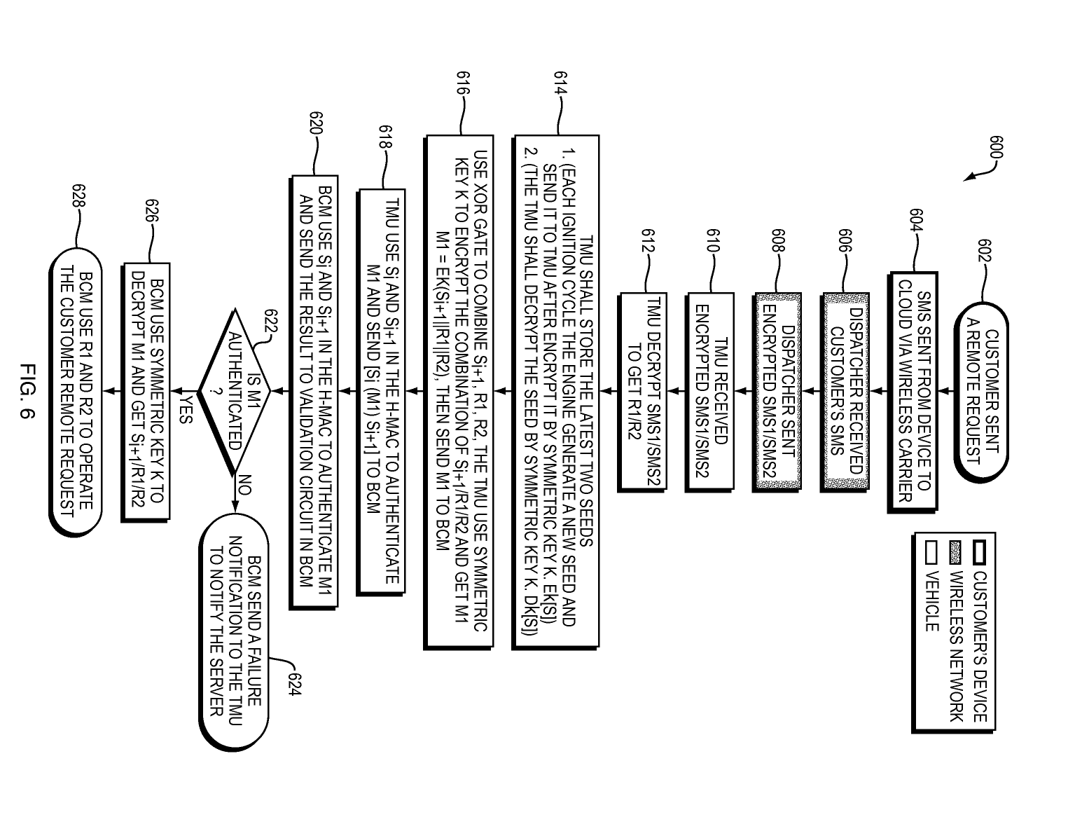

Referring now to FIG. 6, a flow diagram of a process 600 for securing a remote message sent to a controller of a vehicle is shown. In general, process 600 allows remote control commands to be communicated to a vehicle as text-based messages (e.g., as SMS text). Process 600 also allows for data security by encrypting both extra- and intra-vehicle communications.

Process 600 includes steps 602-604, which may be performed by a user's device, such as a mobile or desktop computing device. At step 602, the user's device receives a remote control command request from a user interface (e.g., a keypad, touch screen display, etc.). In step 604, the device generates a corresponding text-based control command (e.g., an SMS based message) and sends the command to a dispatcher service via a wireless network carrier.

Process 600 also includes steps 606-608, which may be performed by a dispatcher service in response to receiving a text-based control command from a user's device. At step 606, the dispatcher receives the text-based control command from the user's device. At step 608, the dispatcher then generates two encrypted messages that contain the text received from the user's device and forwards the encrypted messages to the vehicle. In one embodiment, the dispatcher sends the messages at different times, thereby allowing the vehicle to verify that the dispatcher actually sent the messages.

Process 600 also includes a number of steps that may be performed by the vehicle receiving the remote control command to decrypt the control command. At step 610, the encrypted messages sent by the dispatcher service in 508 are received by the TMU of the vehicle. At step 612, the TMU decrypts the received messages to obtain the original text contained in the two messages (e.g., R1 and R2). In one embodiment, the TMU utilizes a shared key that is set by the manufacturer of the TMU or a servicer of the TMU and made available to the dispatcher service. Such a key may be hardcoded or may be updatable, in various embodiments. For example, a dealership may be able to update the shared key used by the TMU to decrypt remote control commands.

Process 600 also includes a number of steps that may be performed by the vehicle to secure the extra-vehicle communication of the control command to the destination controller. In step 614, the TMU of the vehicle stores and retrieves the latest two seed values generated during subsequent ignition cycles of the vehicle. In one embodiment, the TMU uses a key (K) that is shared with the controller that generates the seed values to decrypt the encrypted seed values sent to the TMU by the generating controller. In step 616, the TMU combines the command text (R1, R2) with the latest seed value (Sᵢ₊₁) into a combined message, encrypts the combined message using the symmetric key K, and sends the encrypted message to the BCM of the vehicle. In step 618, the TMU also uses the latest two seed values (Si and Sᵢ₊₁) to generate and send an authentication string to the BCM.

In steps 620 of process 600, the BCM of the vehicle uses the latest seed values and the authentication string received from the TMU to verify that the encrypted message (M1) received by the BCM was sent by the TMU. At step 622, the BCM determines whether or not the received, encrypted message has been authenticated. If the authentication fails, process 600 proceeds to step 624 in which the BCM sends a failure notification back to the TMU of the vehicle. Such a failure notification may then be forwarded by the TMU to the dispatcher and/or the customer's device. If the authentication succeeds, however, process 600 proceeds to step 626 in which the BCM uses its symmetric key (K) to decrypt the received message. In other words, the BCM extracts the original text command (R1, R2) and the seed value (Sᵢ₊₁) from the combined message. In step 628, the BCM of the vehicle then executes the control command by controlling the appropriate ECM or ECU of the vehicle.

While the embodiment of the present disclosure has been described in detail, the scope of the right of the present disclosure is not limited to the above-described embodiment, and various modifications and improved forms by those skilled in the art who use the basic concept of the present disclosure defined in the appended claims also belong to the scope of the right of the present disclosure.

What is claimed is:

1. A method for performing a remote control operation in a vehicle comprising:
receiving, at telematics electronics of a vehicle, versions of a remote control command sent wirelessly to the vehicle by a dispatcher service, wherein the versions of the remote control command are text-based messages encrypted by the dispatcher service using a first encryption mechanism;
decrypting the versions of the remote control command received from the dispatcher service into a plain text command;
encrypting the plain text command using a second encryption mechanism for use within the vehicle; and
providing the command encrypted using the second encryption mechanism to another controller within the vehicle.

2. The method as in claim 1, wherein the second encryption mechanism is based in part on a seed value generated during an ignition cycle of the vehicle.

3. The method as in claim 2, further comprising:
receiving an encrypted version of the seed value at the telematics electronics;
decrypting the received version of the seed value; and
storing the seed value in memory.

4. The method as in claim 1, further comprising:
comparing transmittal times associated with the versions of the control command received from the dispatcher service to authenticate the control command.

5. The method as in claim 1, wherein the versions of the control command received from the dispatcher are short message service (SMS) text messages.

6. The method as in claim 1, wherein the command encrypted using the second encryption mechanism is provided to a body control module (BCM) of the vehicle.

7. The method as in claim 1, wherein the command encrypted using the second encryption method is provided to the other control module in the vehicle via a control area network (CAN) bus.

8. The method as in claim 1, further comprising:
generating an authentication string associated with the command encrypted using the second encryption mechanism; and
providing the authentication string in conjunction with the command encrypted using the second encryption mechanism to the other controller.

9. The method as in claim 8, wherein the authentication string comprises a hash of the command and two seed values generated during the latest two ignition cycles of the vehicle.

10. An apparatus comprising:
one or more network interfaces adapted to communicate in a vehicle;
a processor adapted to execute one or more processes; and
a memory configured to store a process executable by the processor, the process when executed operable to:
receive versions of a remote control command sent wirelessly to the vehicle by a dispatcher service, wherein the versions of the remote control command are text-based messages encrypted by the dispatcher service using a first encryption mechanism;
decrypt the versions of the remote control command received from the dispatcher service into a plain text command;
encrypt the plain text command using a second encryption mechanism for use within the vehicle; and
provide the command encrypted using the second encryption mechanism to another controller within the vehicle.

11. The apparatus as in claim 10, wherein the second encryption mechanism is based in part on a seed value generated during an ignition cycle of the vehicle.

12. The apparatus as in claim 10, wherein the process when executed is operable to:
compare transmittal times associated with the versions of the control command received from the dispatcher service to authenticate the control command.

13. The apparatus as in claim 10, wherein the versions of the control command received from the dispatcher are short message service (SMS) text messages.

14. The apparatus as in claim 10, wherein the command encrypted using the second encryption method is provided to the other control module in the vehicle via a control area network (CAN) bus.

15. The apparatus as in claim 10, wherein the process when executed is operable to:
generate an authentication string associated with the command encrypted using the second encryption mechanism; and
provide the authentication string in conjunction with the command encrypted using the second encryption mechanism to the other controller.

16. The apparatus as in claim 15, wherein the authentication string comprises a hash of the command and two seed values generated during the latest two ignition cycles of the vehicle.

17. An apparatus comprising:
one or more network interfaces adapted to communicate in a vehicle;
a processor adapted to execute one or more processes; and
a memory configured to store a process executable by the processor, the process when executed operable to:
receive an encrypted command from telematics electronics of the vehicle, wherein the command was received by the telematics electronics from a remote location outside of the vehicle;
authenticate that the encrypted command was sent by the telematics electronics;
decrypt the encrypted command if the encrypted command is authenticated; and
provide the decrypted command to a controller of the vehicle.

18. The apparatus of claim 17, wherein the encrypted command is received via a control area network (CAN) bus.

19. The apparatus of claim 17, wherein the encrypted command is authenticated using an authentication string received in conjunction with the encrypted command.

20. The apparatus of claim 17, wherein the encrypted command is decrypted using a seed value generated during an ignition cycle of the vehicle.
